(19) United States
(12) Patent Application Publication
(10) Pub. No.: US 2007/0223048 A1
(43) Pub. Date: Sep. 27, 2007

(54) Remote control apparatus, system and method

(75) Inventors: Takeshi Misawa, Asaka-shi (JP); Sumie Mikami, Asaka-shi (JP); Atsushi Misawa, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/723,908

(22) Filed: Mar. 22, 2007

(30) Foreign Application Priority Data
Mar. 24, 2006 (JP) 2006-084031

(51) Int. Cl. H04N 1/23

(52) U.S. Cl. 358/302; 358/502

(57) ABSTRACT

According to a remote control apparatus of the present invention, the selection of the control content such as power on or power off to be commonly practiced for each devices is accepted, and the control signal corresponding to the accepted control content is transmitted to all or part of the devices. In this manner, it is possible to remotely control the devices simultaneously, which is convenient when the powers of household electric appliances are turned off simultaneously before going out.

### BACKGROUND OF THE INVENTION

1. Field of the Invention

The present invention relates to a technique for acquiring device-specific information with an image pickup element, and remotely controlling a desired device based on the acquired device-specific information.

2. Description of the Related Art

Conventionally, there is a technique for acquiring positional information from the photographed landscape image to obtain the information relevant to its position. The patent documents 1 to 3 listed below are related to such technique.

Also, conventionally, a multi-functional remote controller capable of remotely controlling a plurality of apparatuses has been developed. The patent document 4 indicated below is related to such technique.

In recent years, various techniques for controlling a desired apparatus intuitively and plainly with a single controller have been developed. For example, in non-patent document 1 indicated below, a custom image sensor mounted on a portable telephone is used to receive an ID from the apparatus, while picking up the normal image in real time. The received ID is superposed on the photographed background image and displayed on a display. The user can perform the operation while visually checking the object apparatus and its ID on the display.

[Patent document 1] Japanese Patent Application Laid-Open No. 2003-330953

[Patent document 2] Japanese Patent Application Laid-Open No. 2003-323440

[Patent document 3] Japanese Patent Application Laid-Open No. 2002-247045

[Patent document 4] Japanese Patent Application Laid-Open No. 2005-348213

[Non-patent document 1] “Proposal of‘OPTO-NAVI’ System, which is an information-appliance multi-purpose remote controller using a low power consumption ID-receiving CMOS image sensor having a function of reading a partial area at a high speed” (The Journal of the Institute of Image Information and Television Engineers Vol. 59, No. 12, pp. 1830-1840 (2005))

### SUMMARY OF THE INVENTION

The patent documents 1 to 4 and non-patent document 1 did not disclose any specific techniques for controlling a plurality of apparatuses simultaneously.

The invention has been achieved in the light of the above-mentioned problem, and it is an object of the invention to remotely control the devices of operation object from the remote site visually plainly and collectively.

According to the present invention, there is provided a remote control apparatus comprising an acquisition section which acquires continually an image of a device to be remotely controlled as a subject and information specific to the device which is optically transmitted from the device with an image pickup element, a display section which superposes the image acquired continually by the acquisition section and the information specific to the device to display the superposed image, an instruction acceptance section which accepts an instruction of a desired control content for the device from which the information specific to the device is acquired from a user, and a remote controlling section which transmits simultaneously a control signal corresponding to the desired control content accepted by the instruction acceptance section to some or all of the devices from which the information specific to the device is acquired.

With the invention, the selection of the control content such as power on or power off to be commonly practiced for each device is accepted, and the control signal corresponding to the accepted control content is transmitted to all or part of the devices.

In this manner, it is possible to remotely control the devices simultaneously, which is convenient when the powers of household electric appliances are turned off simultaneously before going out.

Herein, the remote control device further comprises a state acquisition section which acquires a state information of the device, wherein the remote controlling section transmits a control signal of the control content corresponding to the state information of the device acquired by the state acquisition section to some or all of the devices so that the devices may perform an operation of the desired control content simultaneously.

Since there is a device already in the state intended by the user among the devices, the device may be put in an opposite state to the intended state by transmitting the same control signal simultaneously. Thus, it is preferred that the state of the device is acquired, and the control signal is transmitted in accordance with the state of the device.

Herein, the state acquisition section acquires at least one of the state information superposed on the information specific to the device transmitted from the device, the state information transmitted from the device in accordance with a state information transmission request originated from the remote controlling section, and the state information corresponding to the display information of a display unit for displaying the state information acquired from the device.

The display section may display a screen for accepting an instruction of the desired control content for the device from which the information specific to the device is acquired from the user, and the instruction acceptance section may accept an instruction of the desired control content for the device from which the information specific to the device is acquired via the screen.

The display section may superpose the image and the screen so that the information specific to the device and the screen do not overlap and display the superposed image.

In this manner, the image and the information can be displayed visibly on the screen.

The instruction acceptance section may accept an instruction of selecting the information specific to the desired device to be remotely controlled among the devices from which the information specific to the device is acquired and selecting the desired control content for the device from which the information specific to the device is selected from the user, and the remote controlling section may transmit a remote control signal corresponding to the control content selected by the instruction acceptance section from the instruction acceptance section to the device from which the information specific to the device is selected.

According to the invention, there is provided a remote control system comprising a device which optically transmits information specific to the device, an acquisition section which acquires continually an image of the device to be remotely controlled as a subject and the information specific to the device optically transmitted from the device with an image pickup element, a display section which superposes the image acquired continually by the acquisition section and the information specific to the device to display the superposed image, an instruction acceptance section which accepts an instruction of a desired control content for the device from which the information specific to the device is acquired from the user, and a remote controlling section which transmits simultaneously a control signal corresponding to the desired control content accepted by the instruction acceptance section to a part or all of the devices from which the information specific to the device is acquired.

Also, according to the invention, there is provided a remote control method comprising a step of acquiring continually an image of a device to be remotely controlled as a subject and information specific to the device which is optically transmitted from the device with an image pickup element, a step of superposing the image acquired continually in the step of acquiring and the information specific to the device to display the superposed image, a step of accepting an instruction of a desired control content for the device from which the information specific to the device is acquired from a user, and a step of transmitting simultaneously a control signal corresponding to the desired control content accepted in the step of accepting an instruction to a part or all of the devices from which the information specific to the device is acquired.

With this invention, the selection of the control content such as power on or power off to be commonly practiced for each device is accepted, and the control signal corresponding to the accepted control content is transmitted to all or part of the devices. In this manner, it is possible to remotely control the devices simultaneously, which is convenient when the powers of household electric appliances are turned off simultaneously before going out.

### BRIEF DESCRIPTION OF THE DRAWINGS

FIG. 1 is a configuration view of a remote control system according to a first embodiment;

FIG. 2 is a block diagram of a remote control device;

FIG. 3 is a flowchart showing the flow of a remote control process according to the first embodiment;

FIG. 4 is a view showing one example of a graphical user interface for accepting an instruction for simultaneous control;

FIG. 5 is a view showing one example of a graphical user interface for accepting an instruction with the content of simultaneous control;

FIG. 6 is a configuration view showing an example of a remote control system according to a second embodiment;

FIG. 7 is a block diagram of the essence of the apparatus;

FIG. 8 is a flowchart showing the flow of an apparatus state discrimination system process according to the second embodiment;

FIG. 9 is a configuration view showing another example of the remote control system according to the second embodiment;

FIG. 10 is an explanatory concept view showing the information originated by a device-specific information origination part;

FIG. 11 is a diagram showing one example of the display content of the display unit and the corresponding control content of the apparatus;

FIG. 12 is a flowchart showing the flow of an apparatus state discrimination process according to a third embodiment;

FIG. 13 is a schematic configuration view of a remote control system according to a fourth embodiment;

FIG. 14 is a view showing one example of the configuration of the display unit;

FIGS. 15A and 15B are views showing one example of the time-division multiplexed state indicators;

FIG. 16 is a view displaying the icons of the apparatuses arranged in parallel;

FIG. 17 is a view showing a remote control integrated operation terminal connected to the apparatus via a wireless station; and

FIG. 18 is a flowchart showing the flow of a still image display operation according to a fifth embodiment.

### DETAILED DESCRIPTION OF THE PREFERRED EMBODIMENTS

### First Embodiment

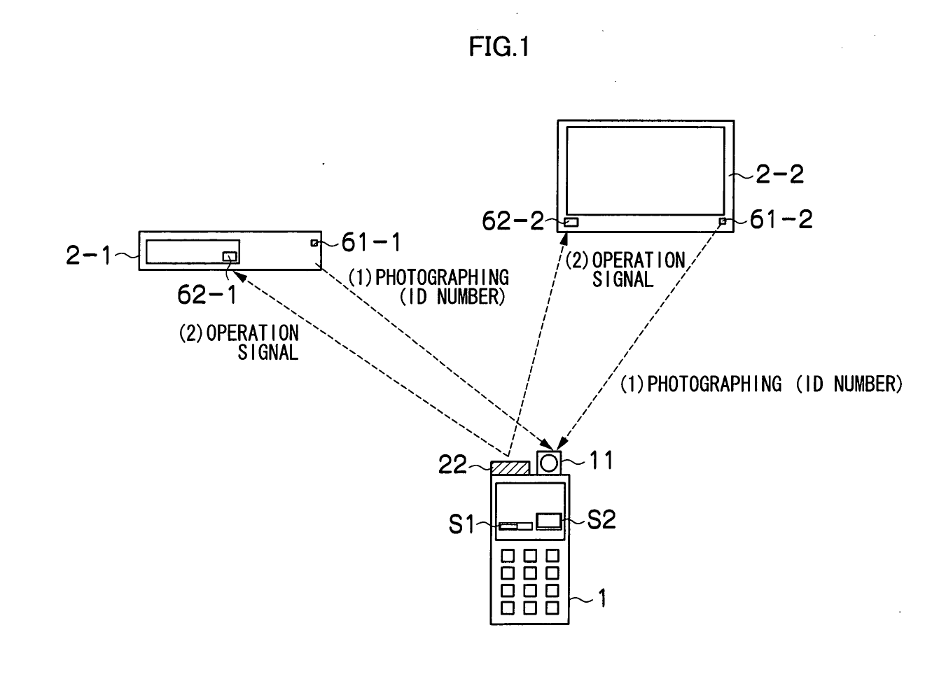

FIG. 1 is a schematic configuration view of a remote control system according to a preferred first embodiment of the present invention. This system comprises a remote control apparatus 1 and various devices 2 such as an AV device 2-1, a television 2-2 and so forth, which are controlled by the remote control apparatus 1.

The device 2 comprises a device-specific information origination part 61 for originating the device-specific information that is specific to the device itself (any device-specific information of the device 2 such as identification number, ID, serial number, manufacturer number, type number, model, or external network address for device 2), which is superposed on an optical signal such as an infrared signal, and a receiving part 62 for receiving a remote control signal (originated by an infrared signal or other optical signal or Bluetooth or other electrical signal) from the remote control apparatus 1. The device-specific information origination part 61 comprises a light emitting diode or infrared LED.

The device-specific information origination part 61 originates a pilot signal of low frequency superposed on an optical signal of device-specific information. If a light emitting device for the device-specific information origination part 61 is an LED, and originally includes a brightness modulation (change in the brightness level) at the low frequency, the pilot signal is superposed using the brightness modulation. Since ordinary people are familiar with the blinking of the LED, they will not have a feeling of discomfort for the originated pilot signal with the brightness modulation. Also, if the brightness modulation is not made in binary value but the brightness is gradually modulated, there will be no feeling of discomfort.

The receiving part 62 receives a remote control signal from the remote control apparatus 1, and sends the signal to a built-in control unit constituted by a one-chip microcomputer and the like, not shown. The control unit interprets the control content defined by the remote control signal, and controls each block such as a video reproduction circuit and a voice reproduction circuit, not shown, in accordance with its control content.

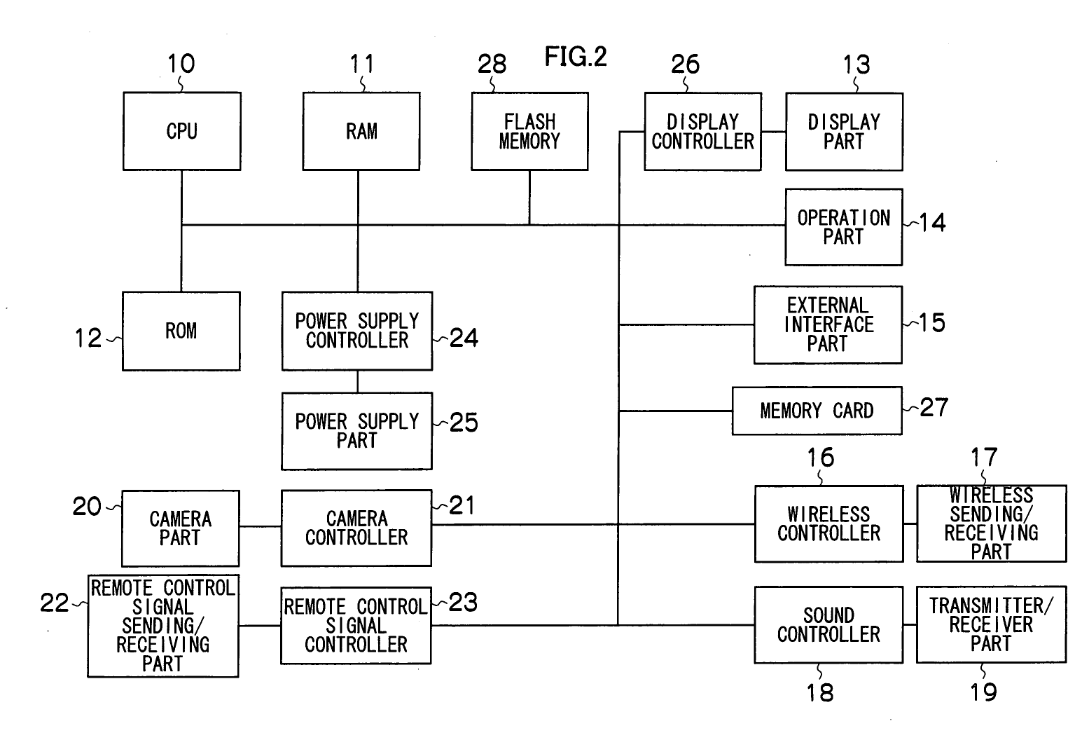

FIG. 2 is a functional block diagram of the remote control apparatus 1 according to a preferred embodiment of the invention. The remote control apparatus 1 comprises a camera part 20 having the signal processing ICs such as an image pickup lens, a solid-state image sensor such as CMOS or CCD, an analog front end IC for processing an analog image read from the solid-state image sensor by a driver into a digital signal, and a DSP (Digital Signal Processor) for processing a digital image signal from the analog front end IC, and a camera controller 21, constituted by a one-chip microcomputer and the like, for controlling the image pickup operation of the camera part 20.

Also, the remote control apparatus 1 comprises a display controller 26 for performing display control for the display part 13 in accordance with an input operation into an operation part 14 having a ten key or a cross key and the like, various kinds of operation signal received from the outside by a remote control signal sending/receiving part 22, or the image or device-specific information acquired by the camera part 20.

Also, the remote control apparatus 1 comprises a CPU 10 for generally controlling each part, a ROM 12 for storing various kinds of data or programs, and a RAM 11 for storing various kinds of data required for processing of the CPU 10.

Particularly, the ROM 12 stores, for each of a plurality of devices 2, a control program for controlling a remote control signal controller 23 or a wireless controller 16 so that the CPU 10 may send a remote control signal with a control code of the device 2 corresponding to an operation on the operation part 14 superposed and a remote control GUI for visually displaying the relationship between each operation of the operation part 14 and the control code superposed by its operation.

For example, an optical double zoom lens is used as the image-taking lens, and the optical zoom magnification is changed by a motor driver forward and backward driving the image-taking lens to the telephotographic (tele) side or the wide-angle (wide) side in accordance with a magnification change operation inputted from the operation section 14. The magnification of the image-taking lens is not limited to the above. An aperture is provided for the image-taking lens. An appropriate amount of exposure is obtained by controlling the aperture via the motor driver.

When the photographing mode is set by the operation section 14, the CPU 10 displays a motion picture (live images) on the display section 13 to enable confirmation of the image-taking angle of field. That is, the solid-state image sensor converts a light of a subject which is incident through the image-taking lens and is formed on the light-receiving surface of the image sensor to an amount of signal charge corresponding to the amount of the light. The signal charges of respective pixels accumulated in this way are sequentially and individually read by the driver as voltage signals (image signals) corresponding to the signal charges, based on a driving pulse given by a timing generator in accordance with a direction from the CPU 10 and converted to digital signals in the analog front-end circuit, and each of them is added to the signal processing circuit.

The signal processing circuit includes a gain adjustment circuit and an A/D converter. It is an image processing device which includes a brightness/color difference signal generation circuit, a gamma correction circuit, a sharpness correction circuit, a contrast correction circuit, a white balance correction circuit, an outline processing section for performing imaging processing including outline correction for a taken image, a noise reduction processing section for performing noise reduction processing of an image and the like, and it processes an image signal in accordance with a command from the CPU 10.

The image data inputted into the signal processing circuit is converted to a brightness signal (Y signal) and a color difference signal (Cr/Cb signal), and the signals are stored in the VRAM after predetermined processings such as gamma correction is performed therefor.

When the monitor output of a taken image to the display section 13 is performed, a Y/C signal is read from the VRAM and sent to a display control section 26. The display control section 26 converts the inputted Y/C signal to a signal of a predetermined method for display (for example, a compound color picture signal of an NTSC method) and outputs it to the display section 13.

The Y/C signals of respective frames which have been processed at a predetermined frame rate are written in an A area and a B area of the VRAM alternatively, and a written Y/C signal is read not from the area in which a Y/C signal is being written but from the other area, between the A and B areas. By the Y/C signals in the VRAM being periodically overwritten, and picture signals generated from the Y/C signals being provided for the display section 13, the picture being taken is displayed on the display section 13 in real time. The user can confirm the image-taking angle of field by the picture (live images) displayed on the display section 13.

Here, when a photographing key provided on the operation section 14 is pressed, a photographing operation for storage is started. Image data acquired in response to the pressing of the photographing key is converted to a brightness/color difference signal (Y/C signal) in the signal processing circuit, and it is stored in the RAM 11 after predetermined processings such as gamma correction are performed therefor.

The Y/C signal stored in the RAM 11 is compressed in accordance with a predetermined format by a compression/expansion processing circuit and then stored in a memory card 27 as an image file in a predetermined format such as an Exif file. The image file can also be stored in a flash memory 28.

When the reproduction mode is set by the operation section 14, the compressed data of the final image file stored in the flash memory 28 (a file stored last) is read. When the file stored last is a still image file, the read compressed image data is expanded to an uncompressed Y/C signal via the compression/expansion processing circuit and stored in the VRAM. The Y/C signal stored in the VRAM is added to the display control section 26. The display control section 26 creates a compound RGB color picture signal of the NTSC method from the inputted Y/C signal and outputs it to the display section 13. Thereby, the frame image of the last frame stored in the memory card 27 is displayed on the display section 13.

After that, when the right key of a cross key provided on the operation section 14 is pressed, frame advancing is performed in the forward direction, and when the left key of the cross key is pressed, frame returning is performed in the opposite direction. Then, an image file at the frame position set by the frame advancing or returning is read from the memory card 27, and a frame image is reproduced on the display section 13 similarly as described above. If frame advancing is performed in the forward direction when the frame image of the last frame is displayed, the image file of the first frame stored in the memory card 27 is read, and the frame image of the first frame is reproduced on the display section 13.

The number of pixels of an image file to be stored is, for example, any of 2832×2128 (6 M), 2048×1536 (3 M), 1280×960 (1 M) and 640×480 (VGA), and the amount of data of a taken image (the file size) changes according to the combination of the stored image quality and the number of stored pixels.

The remote control signal sending/receiving part 22 comprises a light receiving element. In FIG. 2, the camera part 20 and the remote control signal sending/receiving part 22 are provided separately, but practically the light receiving element is common to the solid-state image sensor of the camera part 20. Therefore, if the camera part 20 picks up an image of the device-specific information origination part 61 of the device 2 as the subject S, the device-specific information optically originated by each device 2 can be acquired together with this image.

The remote control signal controller 23 specifies the information origination position based on a detected position of the pilot signal. The remote control signal controller 23 controls the solid-state image sensor of the camera part 20, and performs the still image acquisition operation again at a high frame rate for a portion of information origination position, or at a low frame rate for the other portion. If the frame rate of information acquisition is increased, more information can be transmitted.

The remote control signal controller 23 extracts the device-specific information superposed on an optical signal incident from the external device 2 on the remote control signal sending/receiving part 22 at the information origination position acquired at the high frame rate, and converts it into digital data for output to the CPU 10.

The CPU 10 reads a table defining the control code specific to the device 2 specified by the device-specific information from the ROM 12 into the RAM 11 in accordance with the device-specific information inputted from the remote control signal controller 23. And the CPU reads the control code of the specific device 2 according to an operation of the operation part 14 from the RAM 1 and sends it to the remote control signal controller 23.

The remote control signal sending/receiving part 22 comprises optical signal origination means having a light emitting diode or an infrared LED. The remote control signal controller 23 originates an optical signal to the device 2 by superposing the control code instructed from the CPU 10 and other data on the optical signal. In this manner, it is possible to remotely control the specific device 2 with the operation part 14 by sending the optical control signal from the remote control apparatus 1 to the device 2.

Also, the remote control apparatus 1 comprises an external interface part 15 for communicating with various kinds of electronic apparatus such as a personal computer or a printer in accordance with a USB or other standard.

The remote control apparatus 1 comprises a transmitter/receiver part 19 having sound amplifying means such as a loudspeaker for producing the sound, and receiver means such as an earphone for converting the received sound into electrical signal, and a sound controller 18 for controlling the utterance content of the sound amplifying means.

The CPU 10 can read the control code of the specific device 2 from the RAM 11, according to the sound received by the transmitter/receiver part 19 and send it to the remote control signal controller 23 or the wireless controller 16. That is, the designation of the control code originated by the optical signal or wireless signal to the specific device 2 may be made by sound input, as well as the input operation into the operation part 14.

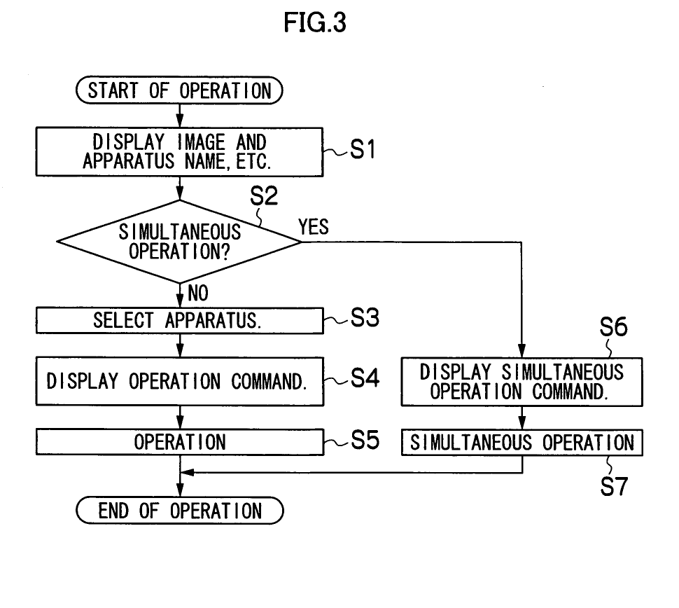

FIG. 3 is a flowchart showing the flow of a remote control process of the remote control apparatus 1.

At S1, the CPU 10 acquires the device-specific information at the information origination position in the still image obtained by the camera part 20. And the CPU generates the video information (typically icon) that can visually identify each device 2 based on the device-specific information, synthesizes the acquired still image and the video information, and displays the synthesized image. If the synthesized position of icon is near the detected position of the pilot signal, it is easy to understand visually and intuitively the relationship between the subject image of each device 2 in the still image and the information originated by the device 2.

At S2, it is judged whether or not a selection of starting an instruction of controlling simultaneously the devices 2 from which the device-specific information is acquired is inputted from the operation part 14. If starting the instruction of simultaneous control is selected, the operation goes to S6, or if staring the instruction of simultaneous control is not selected, the operation transfers to S3.

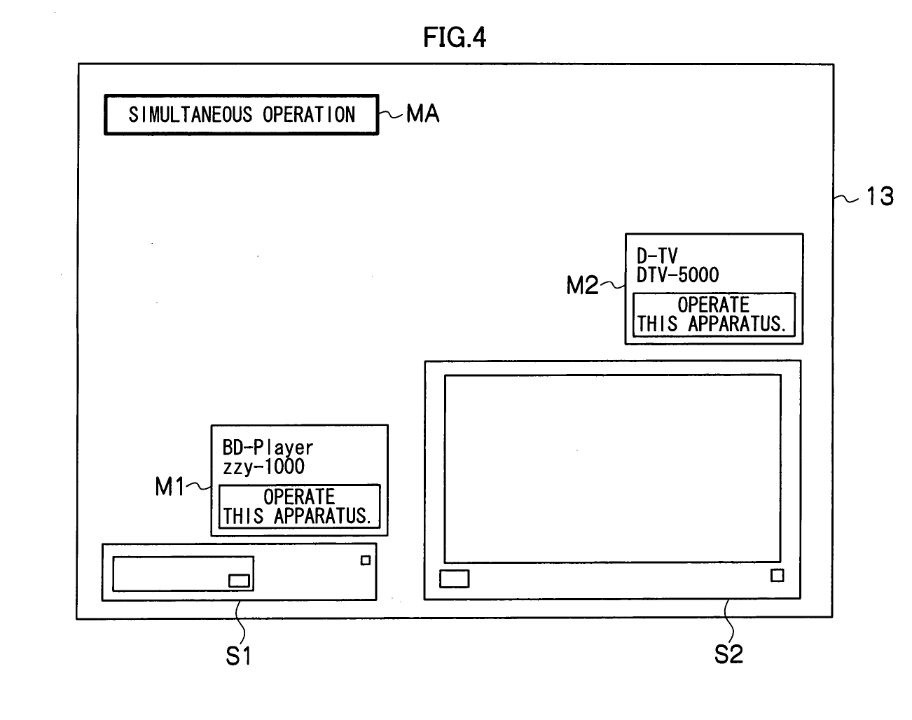

The selection of simultaneous control may be accepted upon a touch operation or a click operation for the “simultaneous operation” of the graphical user interface MA by displaying the interface MA for accepting the selection of “simultaneous operation”, as shown in FIG. 4.

At S3, the CPU 10 accepts the selection of the desired device 2 to be manipulated via the operation part 14.

At S4, the selection of the control content issued to the selected apparatus, for example, power on or change of sound volume is accepted.

At S5, the remote control signal controller 23 originates a remote control signal including the control code defining the selected control content via the remote control signal transmitting/receiving part 22 to the selected specific device 2. The selected device 2 operates according to the remote control signal.

The selection of each device 2 or the selection of the control content may be accepted upon a touch operation or a click operation on the graphical user interface M1, M2 provided for each device 2, as shown in FIG. 4.

At S6, the selection of the common control content such as “power OFF” or “power ON” which is issued to all the devices 2 is accepted.

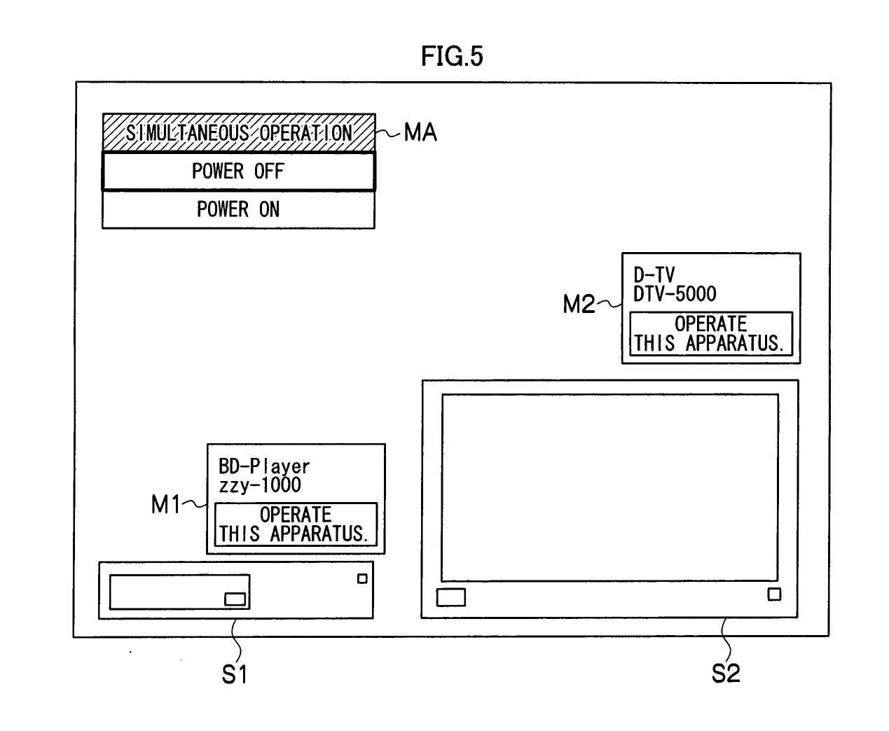

The selection of the control content of simultaneous control may be accepted upon a touch operation or a click operation for the “power OFF” or “power ON” in the graphical user interface MA by displaying the interface MA for accepting the selection of command such as “power OFF” or “power ON”, as shown in FIG. 5.

At S7, the remote control signal controller 23 originates a remote control signal including the control code defining the selected control content via the remote control signal sending/receiving part 22 to each apparatus. The devices 2 perform the common operation according to the remote control signal simultaneously.

Thus, in this embodiment, the user can remotely control the devices individually or simultaneously, using the remote control apparatus 1. Particularly in this embodiment, since the devices 2 can be remotely controlled simultaneously, the remote control apparatus 1 is very convenient for the user who wants the plurality of devices 2 to perform the same operation simultaneously, such as when the user wants to turn off the power of the plurality of devices 2 before going out, or when the user wants to turn on the power of the plurality of devices 2 after return home.

### Second Embodiment

In the first embodiment, if the “simultaneous operation” is selected, the remote control signal is originated indiscriminately, irrespective of the state of the device 2. If the control code simply defines the switching from one state to another such as the switching of the power on or off of the device 2, for example, the power is turned on upon a state switching control signal being sent to the device 2 in a power off state, whereby there is a risk that the control content is against the intent of the user who wants to turn off the power of the devices 2 simultaneously. In this embodiment, such a disadvantage is overcome.

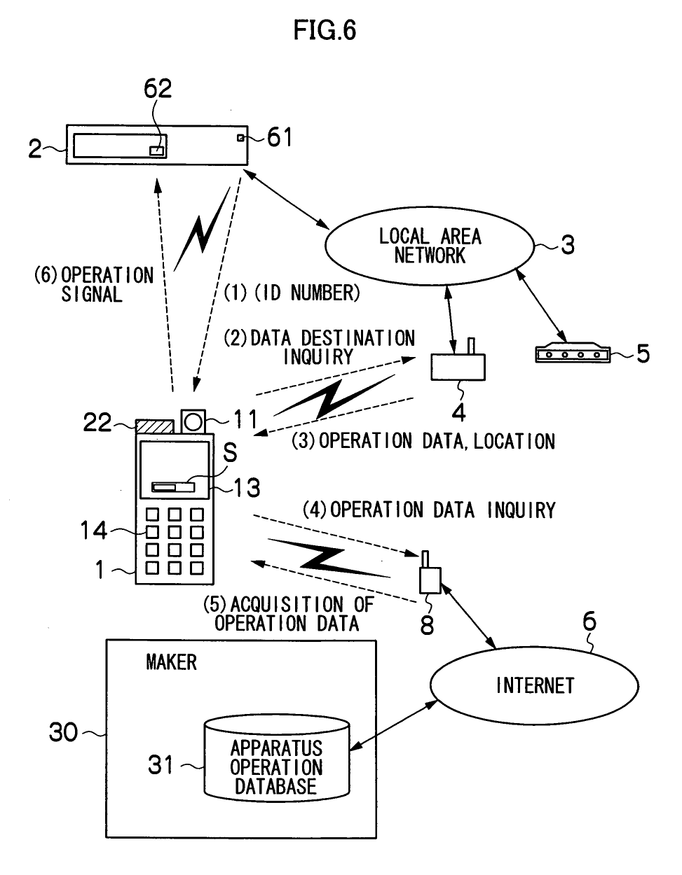

FIG. 6 is a schematic configuration view showing a remote control system according to a preferred second embodiment of the invention.

The device 2 is connected via a LAN 3 or a router 5 to the Internet 6, and the remote control apparatus 1 can be connected to the device 2 via an external network or by wireless communication.

The remote control apparatus 1 transmits or receives various kinds of wireless signal such as a remote control signal via an external interface part 15 to or from a base station 8 or a wireless station 4.

The CPU 10 can send the information designated in accordance with an operation of the operation part 14 to a wireless controller 16. The wireless controller 16 originates a wireless signal with the control code and other information inputted from the CPU 10 superposed to the device 2. This wireless signal is received at the wireless station 4 or the base station 8, and arrives via the LAN 3 or the external network to the device 2. The device 2 receives the information and performs the operation according to the information. In this manner, the information can be transmitted from the remote control apparatus 1 to the device 2 via the network.

The remote control apparatus 1 is connected to the LAN 3 via the external network including the base station 8, a mobile communication network, the Internet 6 and the router 5, or by wireless communication with the wireless station 4. The remote control apparatus 1 makes a request for the information regarding the control of the device 2 to a server 30 connected via the Internet 6, and the server 30 extracts the information regarding the control of the concerned device 2 from an apparatus operation database 31 and sends it to the remote control apparatus 1 in response to the request. In this manner, the control code can be updated. The other configuration is the same as the first embodiment.

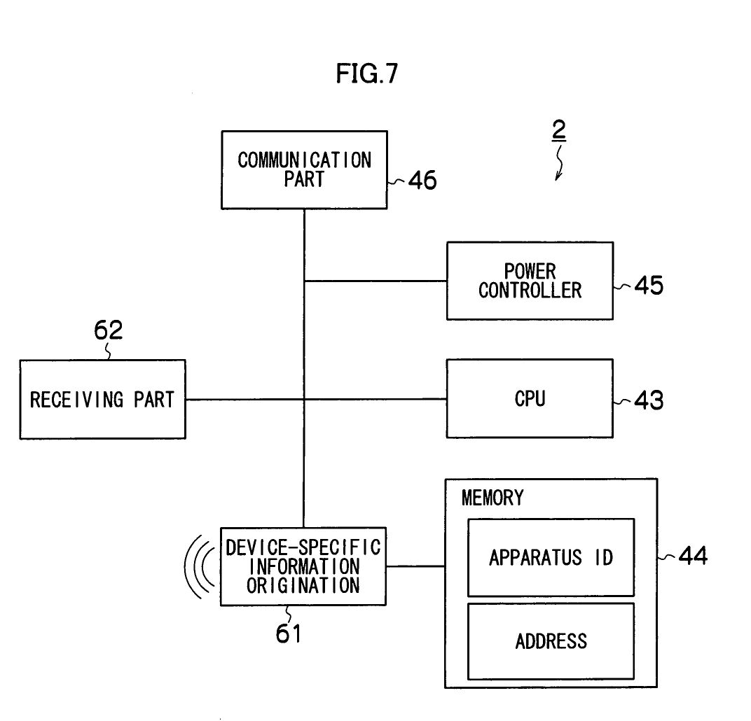

FIG. 7 is a block diagram of the essence of the device 2. The device 2 comprises a device-specific information origination part 61, a receiving part 62, a power supply controller 45, a CPU 43, a memory 44 and a communication part 46.

The device-specific information of the device 2 that is originated by the device-specific information origination part 61, namely, ID of the device 2 and address of the device 2 on the network 3, is accumulated in the nonvolatile memory 44.

The power supply controller 45 controls the power supplied from a battery or an AC adapter, not shown, to be allocated to each block.

The CPU 43 controls the operation of each block of the device 2 in accordance with the control content defined by the remote control signal received by the receiving part 62. Also, the CPU 43 acquires the information indicating whether the current power supply to the block relating to the intrinsic operation of the apparatus (e.g., display of the video by the display unit or amplification of the audio signal by the amplifier if the device 2 is a television) with the power controller 45 is on or off as the state information. The state information is not necessarily limited to the information indicating whether the power supply is on or off. The CPU 43 reflects the latest state to the state information.

A unique address on the network 3 is assigned to the communication part 46, and accumulated in the memory 44. The communication part 46 can communicate with the remote control apparatus 1 via the network 3.

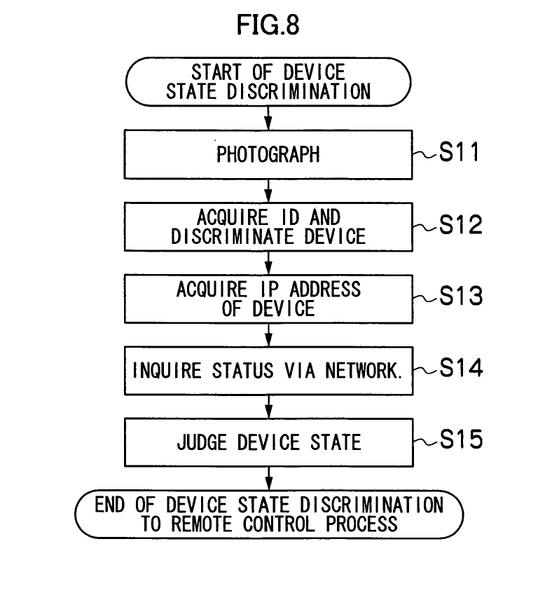

FIG. 8 is a flowchart showing the flow of a device state discrimination process according to the second embodiment.

At S11, the CPU 10 is provided with a still image from the camera part 20.

At S12, the CPU 10 acquires the device-specific information at the information origination position in the still image obtained by the camera part 20. And the CPU 10 generates the video information (typically icon) that can visually identify each device 2 based on the device-specific information, synthesizes the acquired still image and the video information, and displays the synthesized image.

At S13, the address of the device 2 on the network 3, included in the device-specific information, is acquired.

At S14, each device 2 is accessed based on the address on the network 3 to make a request for transmitting the state information. Each device 2 transmits the state information to the remote control apparatus 1 upon the request for transmitting the state information via the network 3.

At S15, the CPU 10 judges, for each apparatus, whether the power supply to the main block of each device 2 is on or off, based on the state information received from each device 2.

Thereafter, the same remote control process as S1 to S7 of FIG. 3 is performed. However, if the “power ON” is selected as the “simultaneous operation” command, a remote control signal defining the control content of switching the state of power is not transmitted to the device 2 in which it is judged that the power supply is already on. Also, if the “power OFF” is selected as the “simultaneous operation” command, the remote control signal defining the control content of switching the state of power is not transmitted to the device 2 in which it is judged that the power supply is already off.

In this manner, since the state of each device 2 is grasped, and the remote control signal is not transmitted to the device 2 that is already in the state intended by the user, it is possible to avoid a situation where the device 2 is put in an opposite state to the state intended by the user due to the simultaneous control.

The state information of each device 2 may be not acquired via the network 3, but may be transmitted directly from each device 2 to the remote control apparatus 1.

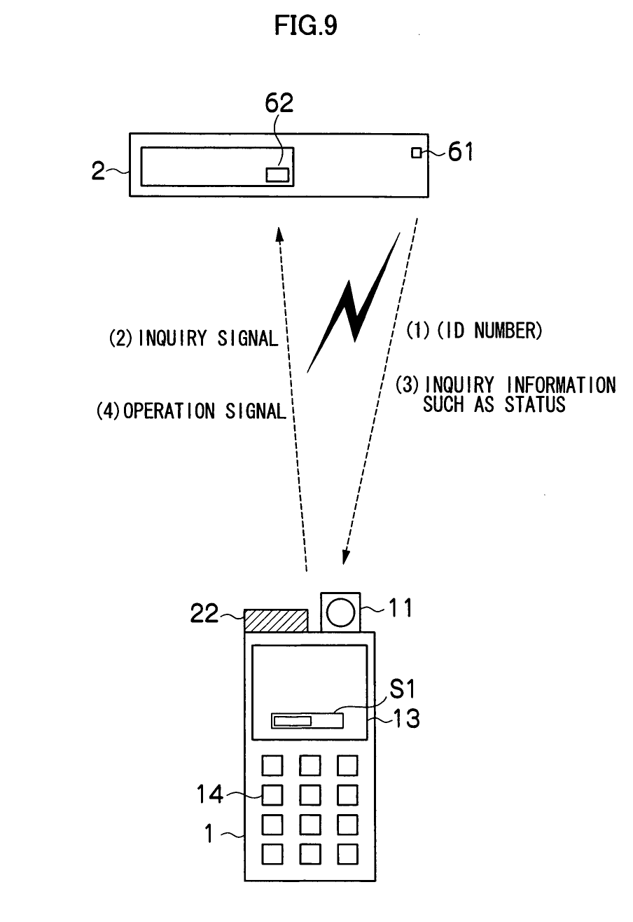

For example, a request signal for originating the state information is transmitted from the remote control signal sending/receiving part 22 of the remote control apparatus 1 to the receiving part 62 of the device 2, as shown in FIG. 9.

The device 2, upon receiving the request, originates the state information that is the information regarding the state of the device 2, together with the device-specific information of the apparatus, from the device-specific information origination part 61.

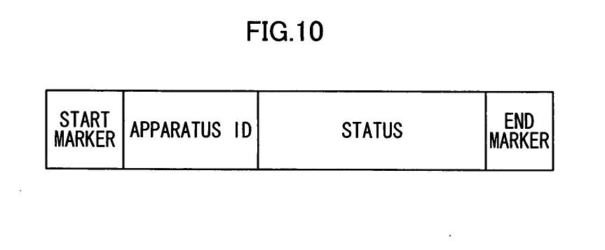

FIG. 10 is an explanatory concept view showing the information originated by the device-specific information origination part 61. As shown in FIG. 10, the device-specific information origination part 61 originates an optical signal including a start marker indicating the start position of information, ID that is the device-specific information of the apparatus, “status” that is state information, and an end marker indicating the end position of information periodically and continually.

The remote control apparatus 1 acquires the state information from the signal optically originated from each device 2. After the state information is acquired, the other process can be made in the same manner as above.

### Third Embodiment

If the device 2 comprises a display unit 63, and the display unit 63 displays the information presenting its own state information, the remote control apparatus 1 may recognize the display content of the display unit 63 in the still image obtained by the camera part 20, and judge the state of the device 2 based on the recognized display content.

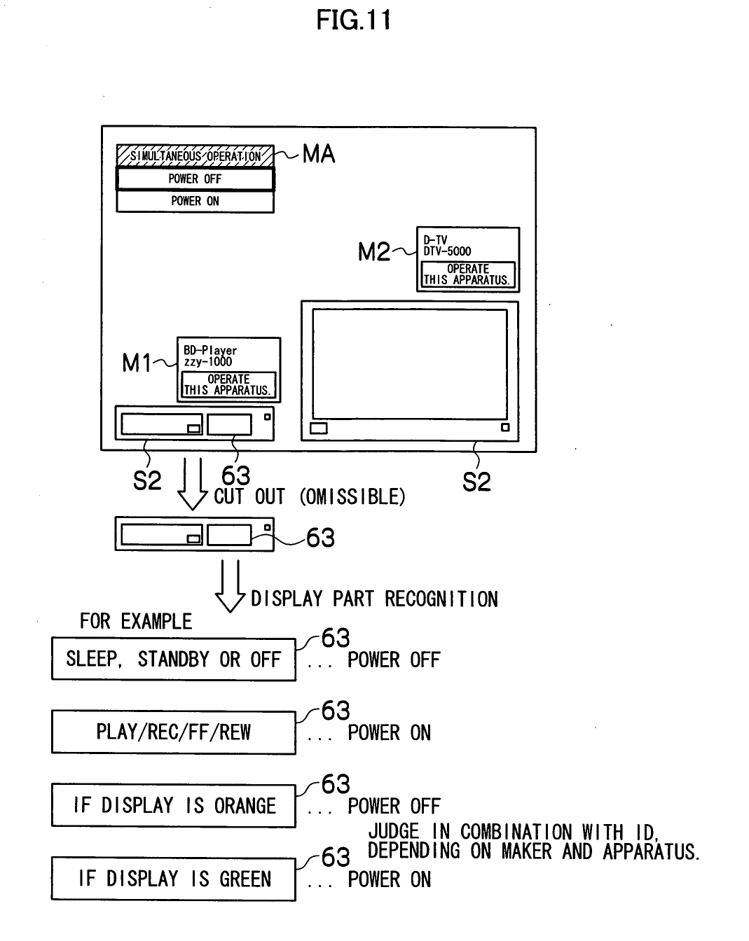

For example, a DVD recorder that is one kind of the device 2 comprises the display unit 63, and the display unit 63 has “SLEEP, standby, OFF”, “PLAY/REC/FF/REW”, “orange display” and “green display”, as shown in FIG. 11.

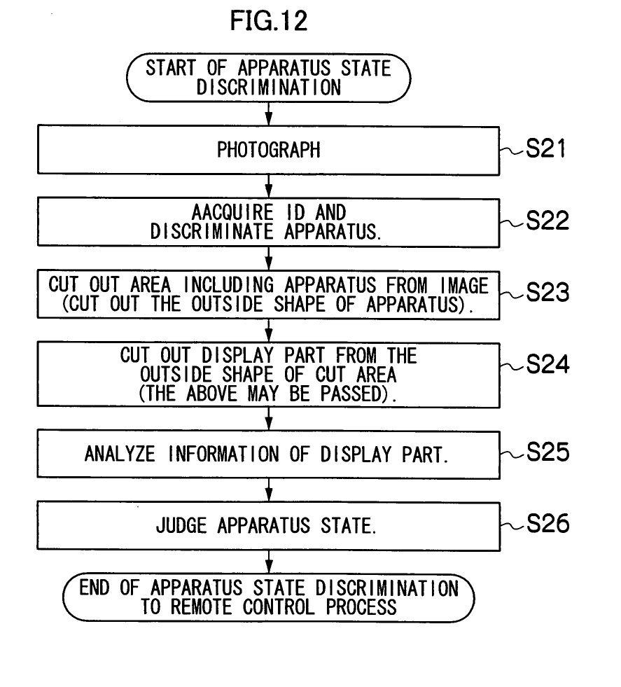

FIG. 12 is a flowchart showing the flow of a device state discrimination process according to a third embodiment.

At S21, the CPU 10 is provided with a still image from the camera part 20.

At S22, the CPU 10 acquires the device-specific information at the information origination position on the still image obtained by the camera part 20. And the CPU 10 generates the video information (typically icon) that can visually identify each device 2 based on the device-specific information, synthesizes the acquired still image and the video information, and displays the synthesized image.

At S23, the CPU 10 cuts out a part of the video of the device 2 as the subject in the still image obtained by the camera part 20.

At S24, the CPU 10 recognizes a video part corresponding to the display content of the display unit 63 from the cut-out video of the device 2, and cuts out its part. However, if the video part corresponding to the display content of the display unit 63 can be directly cut out from the still image, S23 is unnecessary.

At S25, the display content of the display unit 63 is analyzed using various image analysis algorithms such as matching of display patterns or display colors.

At S26, the current state of the apparatus is judged in accordance with the result of analyzing the display content of the display unit 63.

For example, if the display content of the display unit 63 is “SLEEP, standby, OFF”, “PLAY/REC/FF/REW”, “orange display” and “green display”, the state is judged as the “power OFF”, “power ON”, “power OFF” and “power ON”, as shown in FIG. 11.

Thereafter, the remote control signal is transmitted in accordance with the states of the devices 2, so that the devices 2 are controlled simultaneously, as in the second embodiment.

Thus, it is unnecessary to provide a function of originating the state information itself from the device 2 to the remote control apparatus 1.

### Fourth Embodiment

In the second embodiment, if the remote control apparatus 1 is not in the face of the device 2, it can not receive the state information optically originated from the device 2 (although it can receive the state information via the network). In the third embodiment, if the remote control apparatus 1 is not in the face of the device 2, the state of the device 2 can not be discriminated. Thus, in this fourth embodiment, a unit for displaying the states of the devices 2 collectively is provided, and even if the remote control apparatus 1 is not in the face of the device 2, it is possible to control the devices simultaneously in accordance with the states of the devices 2.

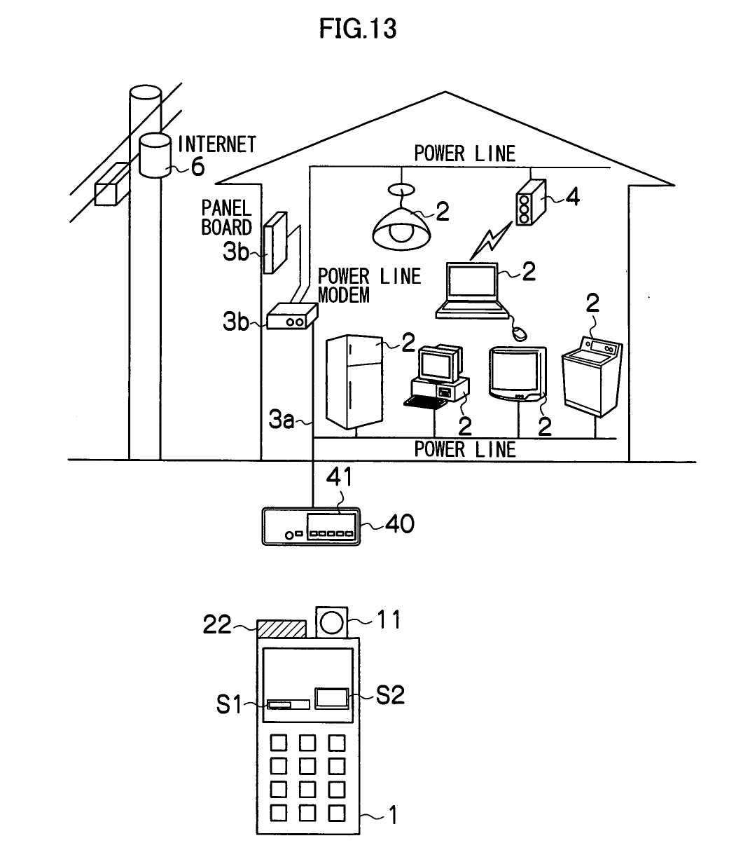

FIG. 13 is a schematic configuration view of a remote control system according to a preferred fourth embodiment of the invention. Herein, each device 2 is connected via a power line network 3a to a remote control integrated operation terminal 40. Also, each device 2 is connected via a power line modem 3b and a panel board 3c to the Internet 6.

The integrated operation terminal 40 acquires the state information of each device 2 via the power line network 3a. The integrated operation terminal 40 comprises a display unit 41 for displaying the acquired state of each device 2. The remote control apparatus 1 can acquire the state of each device 2 by photographing the display unit 41 of the integrated operation terminal 40. The integrated operation terminal 40 may be installed in a porch of the dwelling house or an entry of the living room so that the user can simultaneously turn off the powers of the household electric appliances before going out or simultaneously turn on the powers after return home.

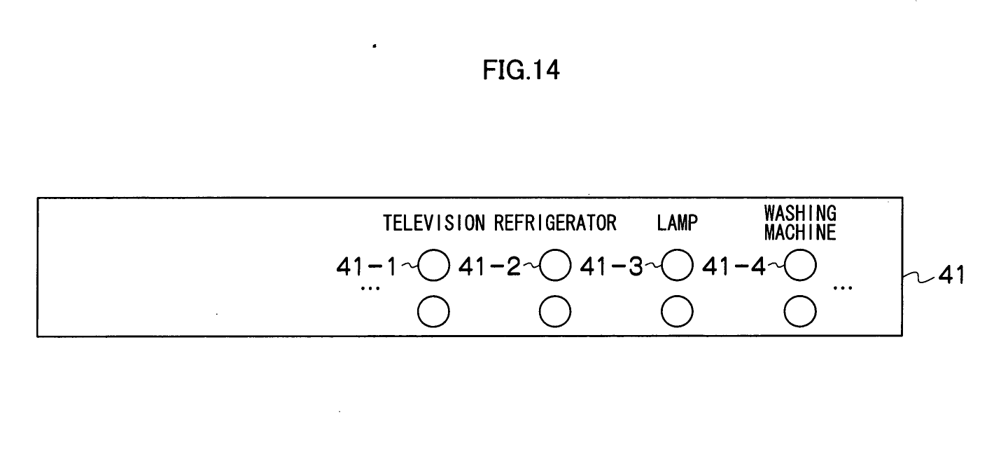

FIG. 14 shows one example of the configuration of the display unit 41. Herein, the display unit 41 is provided with the individual state indicators 41-1, 41-2, . . . corresponding to the devices 2, in which each state indicator 41-1, . . . displays the state of the corresponding device 2.

If there are many devices 2, it is required that many state indicators 41 are correspondingly provided, whereby the process is complex. Therefore, one lamp displays the state of each of the devices 2 at every regular interval (this is called a “time-division multiplexed display”).

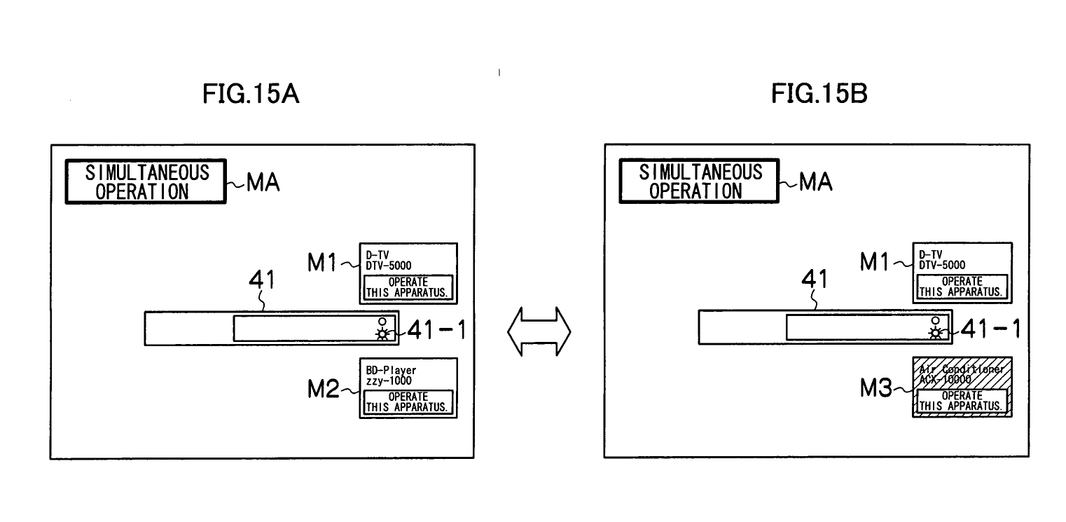

For example, first of all, the state indicator 41-1 displays the state information of one device 2 “BD-Player” for a fixed time, as shown in FIG. 15A. If the integrated operation terminal 40 is photographed by the remote control apparatus 1, an icon M2 of the device 2 “BD-Player” is accordingly displayed on the display part 13.

If the fixed time passes, the state indicator 41-1 displays the state information of another device 2 “Air Conditioner” for the fixed time, as shown in FIG. 15B. If the integrated operation terminal 40 is photographed by the remote control apparatus 1, an icon M3 of the device 2 “Air-Conditioner” is accordingly displayed on the display part 13.

If the fixed time passes, the state indicator 41-1 displays the state information of the device 2 “BD-Player” again for the fixed time. In the following, the same display operation is repeated.

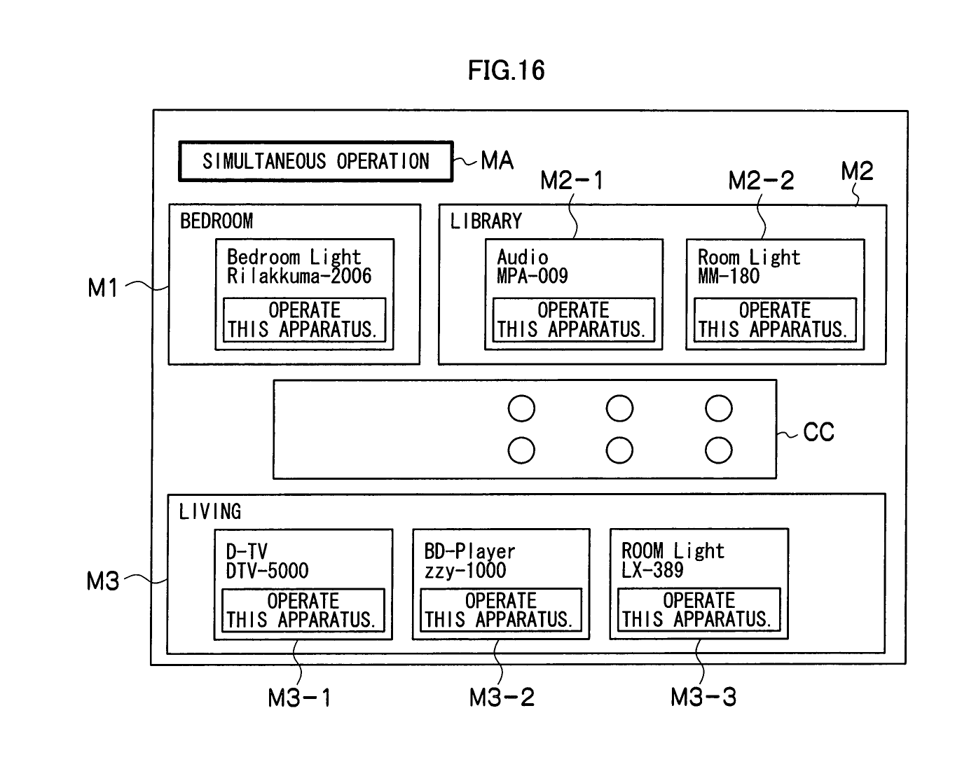

However, if the display of the icon is changed in accordance with an originating period of the state information of the state indicator 41, the display changes rapidly and is difficult to see. Therefore, supposing that the state information of the devices 2 are acquired virtually at the same time, the icons of the devices 2 should be displayed and arranged in parallel, as shown in FIG. 16.

Further, in this case, there are a large number of icons displayed on the display part 13, which is difficult to see. Thus, the icons of the devices 2 in the same state should be displayed, such as only the devices 2 with the power on, or only the devices 2 with the power off. Also, in which state the device 2 is displayed may be selected from the operation part 14.

Or the remote control apparatus 1 may store a history of simultaneous control in the past, in which if the last simultaneous control is power on, the icon of the device 2 in which the current state is power on may be displayed, or if the last simultaneous control is power off, the icon of the device 2 in which the current state is power off may be displayed.

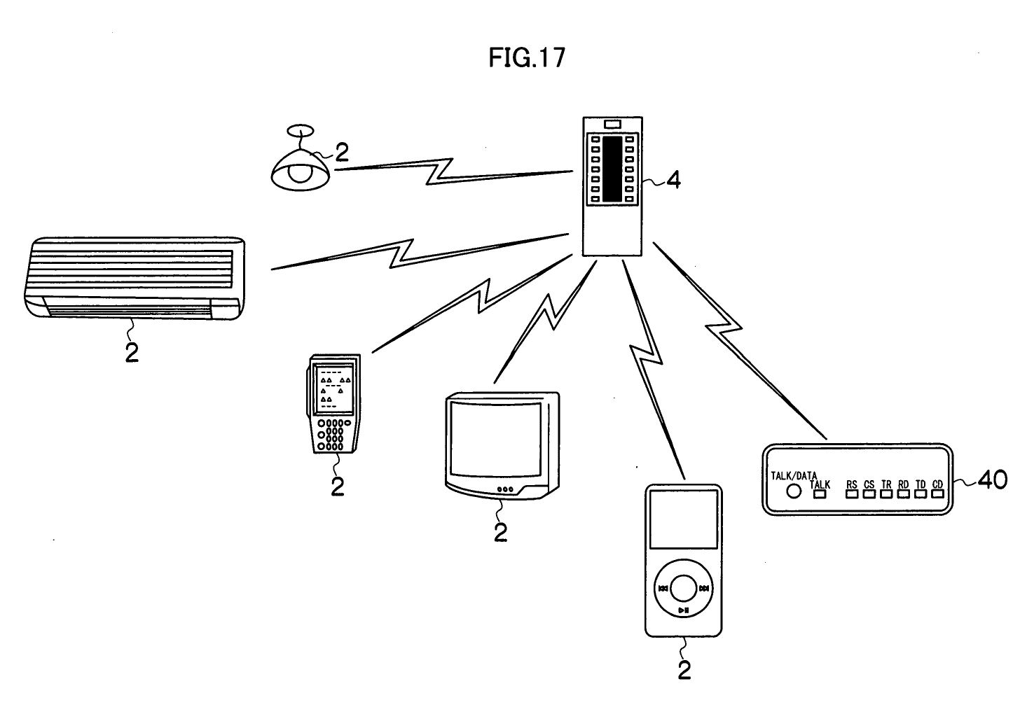

The integrated operation terminal 40 may not be connected to the device 2 via the power line network 3a. For example, it may be connected to the device 2 via the wireless station, as shown in FIG. 17.

### Fifth Embodiment

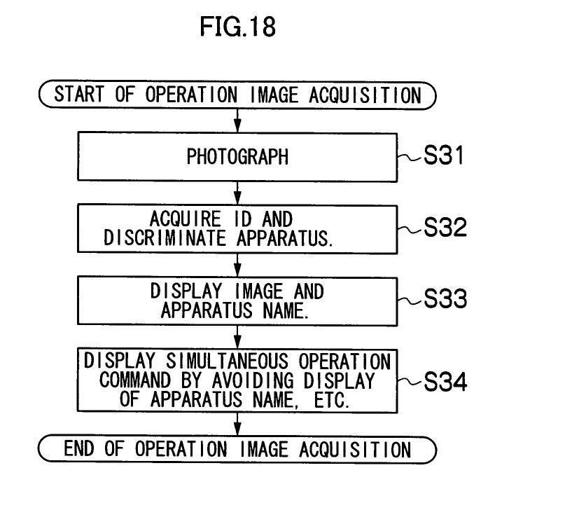

In the first to fourth embodiments, if the user interface MA that accepts the simultaneous control in the display part 13 overlaps the icon or device-specific information of the device 2, the operation of the device 2 becomes difficult to perform. Thus, a still image is acquired by the camera part 20 (S31), the device-specific information of the device 2 is acquired from the still image (S32), the device-specific information of the device 2 and its corresponding icon are displayed on the display part 13 (S33), and the user interface MA is displayed at the position not overlapping the display portion of the device-specific information of the device 2 and its corresponding icon on the display part 13 (S34), as shown in FIG. 18.

In this manner, it is preferred that the user interface MA is displayed so as not to overlap the icon of the device 2.

What is claimed is:

1. A remote control apparatus comprising:
an acquisition section which continually acquires an image of a device to be remotely controlled as a subject and information specific to the device which is optically transmitted from the device with an image pickup element;
a display section which superposes the image acquired continually by the acquisition section and the information specific to the device to display the superposed image;
an instruction acceptance section which accepts an instruction of a desired control content for the device from which the information specific to the device is acquired from a user; and
a remote controlling section which transmits simultaneously a control signal corresponding to the desired control content accepted by the instruction acceptance section to some or all of the devices from which the information specific to the device is acquired.

2. The remote control apparatus according to claim 1, further comprising a state acquisition section which acquires state information of the device,
wherein the remote controlling section transmits a control signal of the control content corresponding to the state information of the device acquired by the state acquisition section to some or all of the devices so that the devices may perform an operation of the desired control content simultaneously.

3. The remote control apparatus according to claim 2, wherein the state acquisition section acquires at least one of the state information superposed on the information specific to the device transmitted from the device, the state information transmitted from the device in accordance with a state information transmission request transmitted from the remote controlling section, and the state information corresponding to the display information of a display unit for displaying the state information acquired from the device.

4. The remote control apparatus according to claim 1, wherein
the display section displays a screen for accepting an instruction of the desired control content for the device from which the information specific to the device is acquired from the user, and
the instruction acceptance section accepts an instruction of the desired control content for the device from which the information specific to the device is acquired via the screen.

5. The remote control apparatus according to claim 2, wherein
the display section displays a screen for accepting an instruction of the desired control content for the device from which the information specific to the device is acquired from the user, and
the instruction acceptance section accepts an instruction of the desired control content for the device from which the information specific to the device is acquired via the screen.

6. The remote control apparatus according to claim 3, wherein
the display section displays a screen for accepting an instruction of the desired control content for the device from which the information specific to the device is acquired from the user, and
the instruction acceptance section accepts an instruction of the desired control content for the device from which the information specific to the device is acquired via the screen.

7. The remote control apparatus according to claim 4, wherein the display section superposes the image and the screen so that the information specific to the device and the screen do not overlap and displays the superposed image.

8. The remote control apparatus according to claim 5, wherein the display section superposes the image and the screen so that the information specific to the device and the screen do not overlap and displays the superposed image.

9. The remote control apparatus according to claim 6, wherein the display section superposes the image and the screen so that the information specific to the device and the screen do not overlap and displays the superposed image.

10. The remote control apparatus according to claim 1, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

11. The remote control apparatus according to claim 2, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

12. The remote control apparatus according to claim 3, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

13. The remote control apparatus according to claim 4, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

14. The remote control apparatus according to claim 5, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

15. The remote control apparatus according to claim 6, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

16. The remote control apparatus according to claim 7, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

17. The remote control apparatus according to claim 8, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

18. The remote control apparatus according to claim 9, wherein
the instruction acceptance section accepts an instruction of selecting the information specific to the desired device to be remotely controlled among the devices from which the information specific to the device is acquired and selecting the desired control content for the device from which the information specific to the device is selected from the user, and
the remote controlling section transmits a remote control signal corresponding to the control content selected by the instruction acceptance section from the instruction acceptance section to the device from which the information specific to the device is selected.

19. A remote control system comprising:
a device which optically transmits information specific to the device;
an acquisition section which continually acquires an image of the device to be remotely controlled as a subject and information specific to the device which is optically transmitted from the device with an image pickup device;
a display section which superposes the image acquired continually by the acquisition section and the information specific to the device to display the superposed image;
an instruction acceptance section which accepts an instruction of a desired control content for the device from which the information specific to the device is acquired from a user; and
a remote controlling section which transmits simultaneously a control signal corresponding to the desired control content accepted by the instruction acceptance section to a part or all of the devices from which the information specific to the device is acquired.

20. A remote control method comprising:
a step of acquiring continually an image of a device to be remotely controlled as a subject and information specific to the device optically transmitted from the device with an image pickup element;
a step of superposing the image acquired continually in the step of acquiring and the information specific to the device to display the superposed image;
a step of accepting an instruction of a desired control content for the device from which the information specific to the device is acquired from a user; and
a step of transmitting simultaneously a control signal corresponding to the desired control content accepted in the step of accepting an instruction to a part or all of the devices from which the information specific to the device is acquired.
